(19) United States
(12) Patent Application Publication
(10) Pub. No.: US 2019/0064398 A1
(43) Pub. Date: Feb. 28, 2019

(54) Durable silver-based mirror coating employing nickel oxide

(71) Applicant: The Regents of the University of California, Oakland, CA (US)

(72) Inventors: Andrew C. Phillips, Seiad Valley, CA (US); Nobuhiko Kobayashi, Sunnyvale, CA (US); David M. Fryauf, Santa Cruz, CA (US)

(21) Appl. No.: 16/111,579

(22) Filed: Aug. 24, 2018

Related U.S. Application Data
(60) Provisional application No. 62/549,513, filed on Aug. 24, 2017.

(51) Int. Cl. G02B 1/18; G02B 5/08; C03C 17/36; F24S 23/70

(52) U.S. Cl. CPC G02B 1/18; G02B 5/0808; C03C 17/3615; H02S 40/22; C03C 17/3644; C03C 17/3663; F24S 23/82; C03C 17/3618

(57) ABSTRACT

A reflective optical coating has a thin film of silver as the primary reflecting material, a thin protective anti-oxidation layer of nickel oxide (NiO) deposited directly on top of the silver layer, and one or more thin transparent barrier layers deposited on top of the NiO, where each barrier layer is composed of a fluoride, a metal oxide, or a nitride. Optionally, a thin protective layer of NiO or Ni may be included, directly beneath the silver layer. Optionally, one or more thin barrier underlayer(s) may be included below the silver (and below the Ni or NiO protective layer, if present), where each of the barrier underlayers is a fluoride, a metal oxide, a metal nitride, or a bare metal.

### CROSS-REFERENCE TO RELATED APPLICATIONS

This application claims priority from U.S. Provisional Patent Application 62/549,513 filed Aug. 24, 2017, which is incorporated herein by reference.

### STATEMENT REGARDING FEDERALLY SPONSORED RESEARCH OR DEVELOPMENT

This invention was made with Government support under contract 1005506 awarded by the National Science Foundation. The Government has certain rights in the invention.

### FIELD OF THE INVENTION

The present invention relates generally to thin-film mirror coatings for optics. More specifically, it relates to durable, silver-based mirror coatings with high reflectivity.

### BACKGROUND OF THE INVENTION

There are a variety of applications for corrosion-resistant mirrors, such as major astronomical telescopes and solar energy collectors. Aluminum mirrors have the advantage of naturally forming a thin layer of barrier oxide for corrosion m resistance. However, in some applications it is desired to have higher reflectivity and lower emissivity in the thermal infrared spectrum. For example, for ground-based telescopes, silver is preferable to aluminum because it is the most reflective metal at most wavelengths of interest for ground-based telescopes. However, silver exposed to air tarnishes due to reactivity with sulfur and oxygen or forms salts with halides. Therefore, to provide a silver mirror with resistance to corrosion, one or more layers of transparent material is deposited on the silver to protect it. However, depending on its material composition, thickness, and other factors, a protective layer can significantly reduce the reflectivity of the mirror at wavelengths of interest.

A well-known silver mirror coating consists of a reflective silver layer between thin layers of nickel-chromium nitride (NiCrN), and a protective barrier layer of Silicon nitride (Si₃N₄). However, NiCrN is highly absorbing of light. As a result, even an extremely thin (i.e., less than 1 nm) layer causes a steep drop in reflectivity at wavelengths less than ˜400 nm. Thus, while this coating successfully protects the silver from corrosion, that protection sacrifices reflectivity of deep blue and UV portions of the spectrum, which is an unacceptable compromise for many astronomical research programs.

Although researchers continue to search for improved silver mirror coatings, identifying suitable materials has proven challenging. There thus remains a long-standing need for a silver mirror coating that reflects efficiently over a broad optical bandwidth, while at the same time providing the silver with long-lasting anti-corrosive protection.

### BRIEF SUMMARY OF THE INVENTION

The inventors have discovered that a reflective silver coating including a very thin (1-10 nm) layer of nickel oxide (NiO) between the silver and a transparent barrier layer provides both high reflectivity across a broad spectrum as well as anti-corrosive protection, even in moist environments. Coatings with this NiO interface layer between silver and the transparent barrier layer demonstrated significant improvement in durability with only a small loss of reflectivity compared to silver alone. The transparent barrier layer is preferably a fluoride, metal oxide, or nitride.

Nickel oxide or pure nickel may also be used as a protective underlayer beneath the silver. Although pure nickel is not suitable for the layer above the silver because it causes a large drop in reflectivity, the inventors have discovered that it can be used advantageously under the silver layer, and may be slightly superior to NiO in terms of durability.

A silver-based mirror coating is thus provided that includes a thin layer of nickel oxide (NiO) deposited directly on a silver reflective layer, with one or more metal oxide, fluoride and/or nitride barrier layers deposited on the NiO layer. The addition of the NiO between the silver and barrier layers provides significantly enhanced protection to the silver from chemical attack in moist environments, while suffering only a small loss in reflectivity. The coating optionally also includes a layer of NiO or Ni below the silver layer. One or more barrier underlayers composed of a fluoride, metal oxide, metal nitride, or bare metal may also be included below the silver layer.

The improved mirror coating provides efficient reflectivity from ˜340 nm through 3 microns in wavelength, and likely through the mid-IR atmospheric window of 8-12 microns. An advantage over existing art for durable mirror coatings is significantly improved reflectivity compared to aluminum and improved ultraviolet and visual range reflectivity over that of the silver/nickel-chromium nitride (NiCrN) coating. The coating may be produced using standard thin-film deposition techniques.

All major astronomical telescopes are likely to benefit from this coating. The coating could be used in mirrors for solar energy collectors, due to increased energy collection. The coating is known to reflect efficiently over the wavelength range of interest for solar energy production. The coating could also be used in the optical communication industry for environments that are less than ideally controlled (e.g., non-vacuum or non-dry).

In one aspect, the invention provides a reflective optical coating deposited on a top surface of a substrate, the reflective optical coating comprising: a silver reflective layer consisting essentially of silver, disposed above the substrate; a protective nickel oxide layer 1-10 nm in thickness consisting essentially of NiO, disposed above the silver reflective layer relative to the substrate and in direct contact with the silver reflective layer; and a transparent barrier layer consisting essentially of a fluoride (e.g., YF₃ or YbF₃), a metal oxide (e.g., TiO₂, Ta₂O₅, Y₂O₃, or Al₂O₃), or a transparent nitride (e.g., Si₃N₄) disposed above the protective nickel oxide layer relative to the substrate and in direct contact with the protective nickel oxide layer.

In one implementation, the silver reflective layer is in direct contact with the substrate, or, alternatively, the reflective optical coating may also include a protective underlayer consisting essentially of NiO or Ni disposed below the silver reflective layer and in direct contact with the silver reflective layer. The protective underlayer may be in direct contact with the substrate, or, alternatively, the reflective optical coating may include a barrier underlayer disposed below the protective underlayer and where the barrier underlayer is in direct contact with the substrate and the protective underlayer. Preferably, the barrier underlayer consists essentially of a fluoride such as YF₃ and YbF₃, a metal oxide such as TiO₂, Ta₂O₅, Y₂O₃ and Al₂O₃, a metal nitride such as TiN and CrN, or a bare metal such as Ni, Cr and Ti.

In one implementation, the reflective optical coating includes a barrier underlayer layer disposed below the silver reflective layer and where the barrier underlayer is in direct contact with the substrate and the silver reflective layer. Preferably, the barrier underlayer consists essentially of YF₃, YbF₃, TiO₂, Ta₂O₅, Y₂O₃, Al₂O₃, TiN, CrN, Ni, Cr, or Ti.

In one implementation, the reflective optical coating may include a second transparent barrier layer consisting essentially of one of YF₃, YbF₃, TiO₂, Ta₂O₅, Y₂O₃, Al₂O₃, or Si₃N₄ disposed above the transparent barrier layer relative to the substrate and in direct contact with the transparent barrier layer.

The silver reflective layer, the protective nickel oxide layer, and/or the transparent barrier layer may be deposited by e-beam, ion-assisted e-beam, sputter, cathodic arc physical vapor deposition, or atomic layer deposition.

### BRIEF DESCRIPTION OF THE SEVERAL VIEWS OF THE DRAWINGS

FIG. 1A is a schematic cross-sectional view of a reflective optical coating 120 deposited on a top surface of a substrate 100, according to an embodiment of the m invention.

FIG. 1B is a schematic cross-sectional view of a reflective optical coating 122 deposited on a top surface of a substrate 100, according to another embodiment of the invention.

FIG. 1C is a schematic cross-sectional view of a reflective optical coating 124 deposited on a top surface of a substrate 100, according to another embodiment of the invention.

FIG. 1D is a schematic cross-sectional view of a reflective optical coating 126 deposited on a top surface of a substrate 100, according to another embodiment of the invention.

FIG. 2 is a graph of measured reflectivity vs wavelength comparing the improved NiO silver reflective coating of the invention with a nickel-chromium nitride (NiCrN) silver reflective coating and a freshly-deposited bare aluminum mirror.

### DETAILED DESCRIPTION OF THE INVENTION

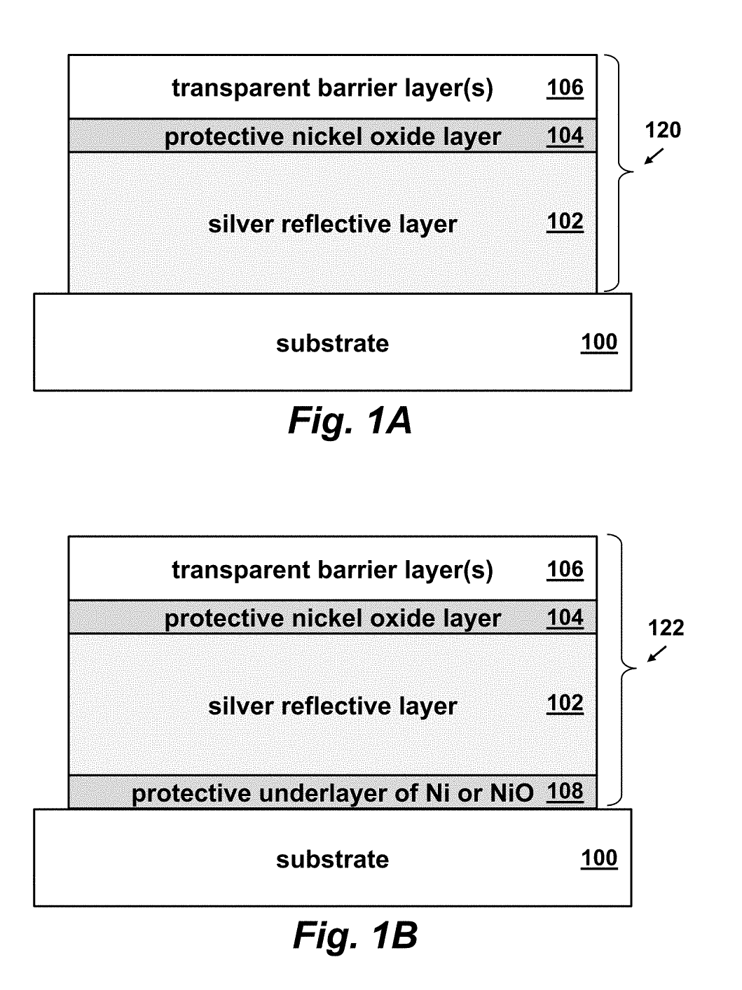

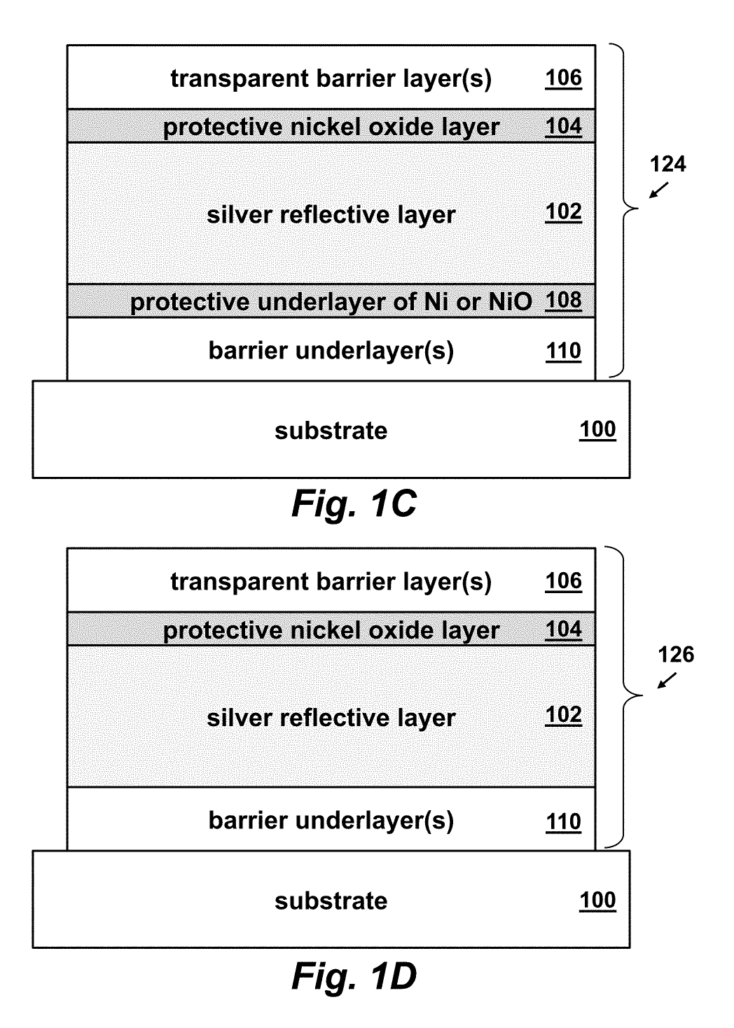

FIG. 1A is a schematic cross-sectional view of a reflective optical coating 120 deposited on a top surface of a substrate 100, according to an embodiment of the invention. The reflective optical coating 120 in this embodiment has a silver reflective layer 102 consisting essentially of silver, disposed above and in direct contact with the substrate 100. A 1-10 nm thick protective nickel oxide layer 104 consisting essentially of NiO is disposed above and in direct contact with the silver reflective layer 102. A transparent barrier layer 106 consisting essentially of one of YF₃, YbF₃, TiO₂, Ta₂O₅, Y₂O₃, Al₂O₃, or Si₃N₄ is disposed above and in direct contact with the protective nickel oxide layer 104. Transparent barrier layer 106 may consist of multiple transparent barrier layers, each consisting essentially of one of YF₃, YbF₃, TiO₂, Ta₂O₅, Y₂O₃, Al₂O₃, or Si₃N₄.

FIG. 1B is a schematic cross-sectional view of a reflective optical coating 122 deposited on a top surface of a substrate 100, according to another embodiment of the invention. This embodiment is identical to the embodiment of FIG. 1A except that the reflective optical coating 122 in this case includes a protective underlayer 108 consisting essentially of NiO or Ni disposed below and in direct contact with the silver reflective layer 102. The protective underlayer is also in direct contact with the substrate 100.

FIG. 1C is a schematic cross-sectional view of a reflective optical coating 124 deposited on a top surface of a substrate 100, according to another embodiment of the invention. This embodiment is identical to the embodiment of FIG. 1B except that the reflective optical coating 124 in this case includes a barrier underlayer 110 disposed below and in direct contact with the protective underlayer 108. The barrier underlayer 110 is also in direct contact with the substrate 100. Preferably, the barrier underlayer consists essentially of one of YF₃, YbF₃, TiO₂, Ta₂O₅, Y₂O₃, Al₂O₃, TiN, CrN, Ni, Cr, or Ti. Barrier underlayer 110 may consist of multiple barrier underlayers, each consisting essentially of one of YF₃, YbF₃, TiO₂, Ta₂O₅, Y₂O₃, Al₂O₃, TiN, CrN, Ni, Cr, or Ti.

FIG. 1D is a schematic cross-sectional view of a reflective optical coating 126 deposited on a top surface of a substrate 100, according to another embodiment of the invention. This embodiment is identical to the embodiment of FIG. 1C except that the reflective optical coating does not include the protective underlayer of Ni or NiO. Instead, the barrier underlayer 110 is in direct contact with the silver reflective layer 102.

The embodiments described above may be generically characterized as a reflective optical thin film coating deposited on a substrate, where the coating includes:
a thin film of silver as the primary reflecting material (preferably 60-180 nm thick, more preferably, 120 nm thick);
a thin protective anti-oxidation layer of nickel oxide (preferably 1-10 nm thick, more preferably, 2 nm thick) deposited directly on top of the silver layer;
one or more thin transparent barrier layers (preferably 8-240 nm thick in total, more preferably 80 nm thick) deposited on top of the NiO, where each of these layers is composed of a fluoride (e.g., YF₃ or YbF₃), a metal oxide (e.g., TiO₂, Ta₂O₅, Y₂O₃, or Al₂O₃), or a transparent nitride (e.g., Si₃N₄);
Optionally, a thin protective layer of NiO or Ni (preferably 1-10 nm thick, more preferably 2 nm thick) directly beneath the silver layer;
Optionally, one or more thin barrier underlayer(s) (preferably 10-50 nm thick, more preferably 40 nm thick) below the silver (and below the Ni or NiO protective layer, if present), where each of the barrier underlayers consists of a fluoride such as YF₃ and YbF₃, a metal oxide such as TiO₂, Ta₂O₅, Y₂O₃ and Al₂O₃, a metal nitride such as TiN and CrN, or a bare metal such as Ni, Cr and Ti.

The coating may have any size up to 10 m in diameter. The substrate material may be optical glass including fused silica; or ultra-low-expansion glass/ceramic mixtures.

The silver reflective layer, the protective nickel oxide layer, and/or the transparent barrier layer may be deposited by e-beam, ion-assisted e-beam, sputter, cathodic arc physical vapor deposition, or atomic layer deposition (ALD).

In one illustrative example, the layers of a coating are deposited on the substrate in the following order: a 22 nm thick Y₂O₃ adhesion-barrier underlayer, a 120 nm thick silver film, a 5±1 nm thick protective layer of NiO, and a 72 nm thick transparent barrier layer of Al₂O₃. The NiO is deposited by a slow evaporation of nickel metal in a background pressure of oxygen to reactively form the oxide; this oxide is most likely sub-stoichiometric. The transparent barrier of Al₂O₃ is deposited by thermal ALD using trimethylaluminum and water for the Al and oxidizer, respectively. It is highly-desired to keep substrate temperatures as low as possible during the coating process, both to reduce risk of damaging expensive substrate optics with thermal cycling, and especially to avoid damaging epoxy bonds in mounting hardware, which is becoming widely practiced. The ALD-barrier layer may be deposited at a common process temperature of 150 C or at a more practical temperature (for epoxy bonds) of 60 C.

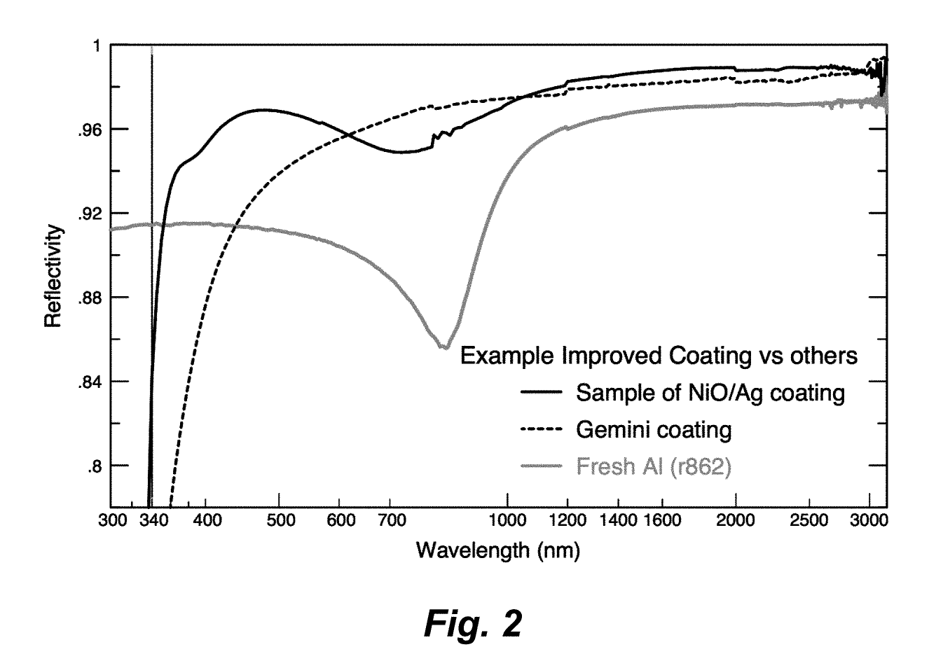

The measured reflectivity of an example of the improved coating is shown in FIG. 2, comparing it with nickel-chromium nitride (NiCrN) silver reflective coating and a freshly-deposited bare aluminum mirror. The improved coating with NiO has comparable reflectivity to the NiCrN coating in the infrared portion of the spectrum, but significantly superior reflectivity at wavelengths in the 350-550 nm range. It also has comparable or significantly greater reflectivity everywhere with respect to aluminum except below ˜340 nm. In the thermal IR, the reflectivity of the silver-based coatings is ˜99%, whereas bare Al is ˜97%, meaning that the emissivity of the silver-based coatings is ⅓ that of aluminum; this is extremely important for observations of faint sources in the infrared.

1. A reflective optical coating deposited on a top surface of a substrate, the reflective optical coating comprising:
a silver reflective layer consisting essentially of silver, disposed above the substrate;
a protective nickel oxide layer 1-10 nm in thickness consisting essentially of NiO, disposed above the silver reflective layer relative to the substrate m and in direct contact with the silver reflective layer;
a transparent barrier layer consisting essentially of one of a fluoride, a metal oxide, or a transparent nitride, where the transparent barrier layer is disposed above the protective nickel oxide layer relative to the substrate and in direct contact with the protective nickel oxide layer.

2. The reflective optical coating of claim 1 where the transparent barrier layer consists essentially of one of YF₃, YbF₃, TiO₂, Ta₂O₅, Y₂O₃, Al₂O₃, or Si₃N₄.

3. The reflective optical coating of claim 1 where the silver reflective layer is in direct contact with the substrate.

4. The reflective optical coating of claim 1 further comprising a protective underlayer consisting essentially of NiO or Ni disposed below the silver reflective layer and in direct contact with the silver reflective layer.

5. The reflective optical coating of claim 4 where the protective underlayer is in direct contact with the substrate.

6. The reflective optical coating of claim 4 further comprising a barrier underlayer disposed below the protective underlayer and where the barrier underlayer is in direct contact with the substrate and the protective underlayer.

7. The reflective optical coating of claim 6 where the barrier underlayer consists essentially of a fluoride, a metal oxide, a metal nitride, or a bare metal.

8. The reflective optical coating of claim 7 where the barrier underlayer consists essentially of YF₃, YbF₃, TiO₂, Ta₂O₅, Y₂O₃, Al₂O₃, TiN, CrN, Ni, m Cr, or Ti.

9. The reflective optical coating of claim 1 further comprising a barrier underlayer layer disposed below the silver reflective layer and where the barrier underlayer is in direct contact with the substrate and the silver reflective layer.

10. The reflective optical coating of claim 9 where the barrier underlayer consists essentially of a fluoride, a metal oxide, a metal nitride, or a bare metal.

11. The reflective optical coating of claim 10 where the barrier underlayer consists essentially of YF₃, YbF₃, TiO₂, Ta₂O₅, Y₂O₃, Al₂O₃, TiN, CrN, Ni, Cr, or Ti.

12. The reflective optical coating of claim 1 further comprising a second transparent barrier layer consisting essentially of one of a fluoride, a metal oxide, or a transparent nitride, where the transparent barrier layer is disposed above the transparent barrier layer relative to the substrate and in direct contact with the transparent barrier layer.

13. The reflective optical coating of claim 12 where the second transparent barrier layer consists essentially of one of YF₃, YbF₃, TiO₂, Ta₂O₅, Y₂O₃, Al₂O₃, or Si₃N₄.

14. The reflective optical coating of claim 1 where the silver reflective layer, the protective nickel oxide layer, and/or the transparent barrier layer is deposited by e-beam, ion-assisted e-beam, sputter, cathodic arc physical vapor deposition, or atomic layer deposition.
